(19) United States
(12) Patent Application Publication
(10) Pub. No.: US 2012/0092858 A1
(43) Pub. Date: Apr. 19, 2012

(54) Flashlight Ventilation Structure

(76) Inventor: Ching-Hsiang Wang, Tainan City (TW)

(21) Appl. No.: 12/903,317

(22) Filed: Oct. 13, 2010

(51) Int. Cl. F21V 29/00

(52) U.S. Cl. 362/202

(57) ABSTRACT

A flashlight ventilation structure includes a ventilation lid screwed at a terminal of a handle portion of a flashlight. The handle portion is formed with a vent so that a rear cap formed with a vent facing the vent is allowed to fittingly cover the terminal of the handle portion The rear cap has a depressed combining region and a cavity circling the vent of the rear cap, so that a barrier whose backside is combined with a breathable fabric is allowed to be set in the cavity. The combining region is fitting covered by a ventilation mask, whereby the ventilation lid attached to the handle portion of the flashlight allows heat generated by batteries inside the flashlight for lighting the flashlight to be dissipated outward through the ventilation lid, while the breathable fabric in the ventilation lid prevents external liquid from permeating into the flashlight.

### BACKGROUND OF THE INVENTION

1. Technical Field

The present invention relates to a flashlight ventilation structure. More particularly, the ventilation structure is one provided to a flashlight that is suitable for illumination in occasions such as mining pits, gas tanks, painting and coating workplaces, etc. The ventilation structure has a lid covering a terminal of the flashlight, so as to allow heat generated by batteries inside the flashlight for lighting a bulb to be dissipated through the ventilation lid, while breathable fabric in the lid prevents external liquid from permeating into the flashlight, thereby ensuring explosion-proof security when the flashlight is used in special workplaces.

2. Description of Related Art

In order to cater for various applications, the existing flashlights are designed by the pertinent manufacturers with diverse forms, which are constructed from different assembly configurations. The related art referred by the present invention are flashlights to be used in occasions of mining pits, gas tanks, painting and coating workplaces, and so on. A flashlight for these purposes must have a flashlight body, as such, formed with the capabilities of being explosion proof and preventing external moisture from intruding thereinto. According to the prior art, the flashlight has a flashlight body of a predetermined shape with a front part configured to be an illumination portion, a middle part configured to be a handle portion, and press switch assembled between the illumination portion and the handle portion to control conductive contacts provided inside the flashlight to form a circuit with batteries installed between the contacts or break such a circuit. Additionally, the handle portion is terminally provided with a lid which is pressed toward and then screwed with the handle portion after batteries are placed in the handle portion.

The lid attached to the handle portion of the flashlight causes a closed space inside the flashlight, so the heat generated by the batteries for lighting a bulb of the flashlight cannot be dissipated outward. In this case, when the flashlight is used in a mining pit, a gas tank, or a painting and coating workplace where flammable gas/dust accumulates to a certain concentration, the heat in contact with such flammable gas/dust is likely to bring about a burst.

In addition, since the existing flashlight has the lid screwed and thereby fixed with the handle portion, the screw locking mechanism tends to loose over time. Once external moisture come in the flashlight through intervals existing in the loosed crew locking mechanism, the conductive contacts and batteries inside the flashlight may not normally work to lighten the flashlight.

### SUMMARY OF THE INVENTION

The present invention is made to improve the shortcomings of the existing flashlights for special purposes by making a flashlight terminally covered by a lid that is designed for ventilation, so as to allow heat generated by batteries inside the flashlight for lighting a bulb to be dissipated outside through the ventilation lid, while breathable fabric in the lid prevents external liquid from permeating into the flashlight, thereby ensuring explosion-proof security when the flashlight is used in special workplaces.

The primary objective of the present invention is to provide a flashlight ventilation structure, which comprises a ventilation lid screwed at a terminal of a handle portion of a flashlight; the flashlight ventilation structure being characterized in: the flashlight having the handle portion formed with a vent so that a rear cap formed with a vent facing the vent is allowed to fittingly cover the terminal of the handle portion, the rear cap having a backside formed with a depressed combining region and a cavity circling the vent of the rear cap, so that a barrier whose backside is combined with a breathable fabric is allowed to be set in the cavity, the barrier being formed with a through hole so as to allow gas to be dissipated outward through the breathable fabric, the combining region at the backside of the rear cap being fitting covered by a ventilation mask, and the ventilation mask having a side opposite to the backside provided with an abutting section that is penetrated by a through hole, wherein the pressingly abutting section serves to abut the barrier set in the cavity of the rear cap; whereby the ventilation lid attached to the handle portion of the flashlight allows heat generated by batteries inside the flashlight for lighting a bulb of the flashlight to be dissipated outward through the ventilation lid, while the breathable fabric in the ventilation lid prevents external liquid from permeating into the flashlight, thereby ensuring explosion-proof security when the flashlight is used in special workplaces.

A second objective of the present invention is to provide the flashlight ventilation structure, wherein a high-frequency means is used to combine the handle portion of the flashlight with the rear cap at peripheries thereof and to combine the ear cap with the ventilation mask at peripheries thereof.

A third objective of the present invention is to provide the flashlight ventilation structure, wherein the flashlight has a peripheral groove formed along a periphery of the handle portion circling the vent, while the rear cap has an inner side formed with a peripheral projection corresponding to the peripheral groove, so that when the rear cap is assembled to the handle portion, the peripheral groove is fittingly received in the peripheral groove, thereby ensuring reliable combination between the rear cap and the handle portion.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is an exploded view of a ventilation lid for a flashlight according to the present invention;

FIG. 2 is another exploded view of the ventilation lid according to the present invention taken from a different viewpoint; and

FIG. 3 is a perspective view of the flashlight assembled with the ventilation lid according to the present invention.

### DETAILED DESCRIPTION OF THE INVENTION

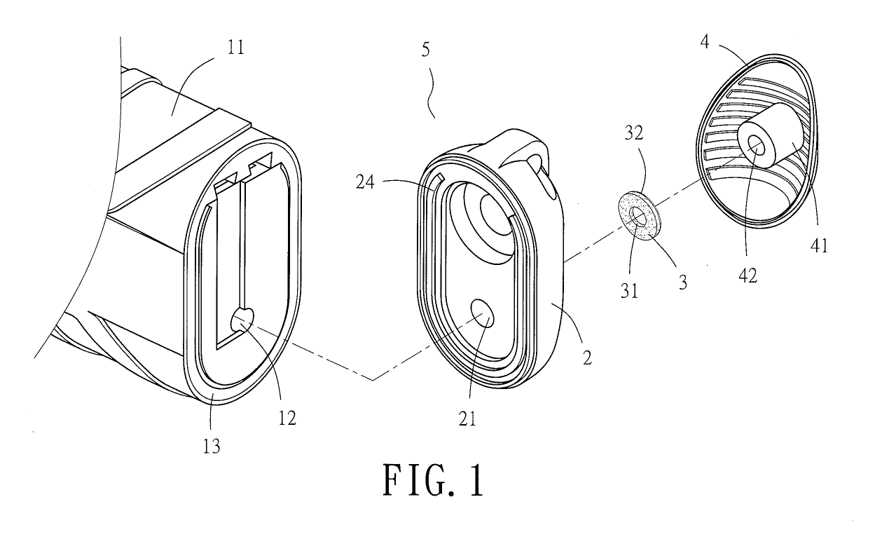

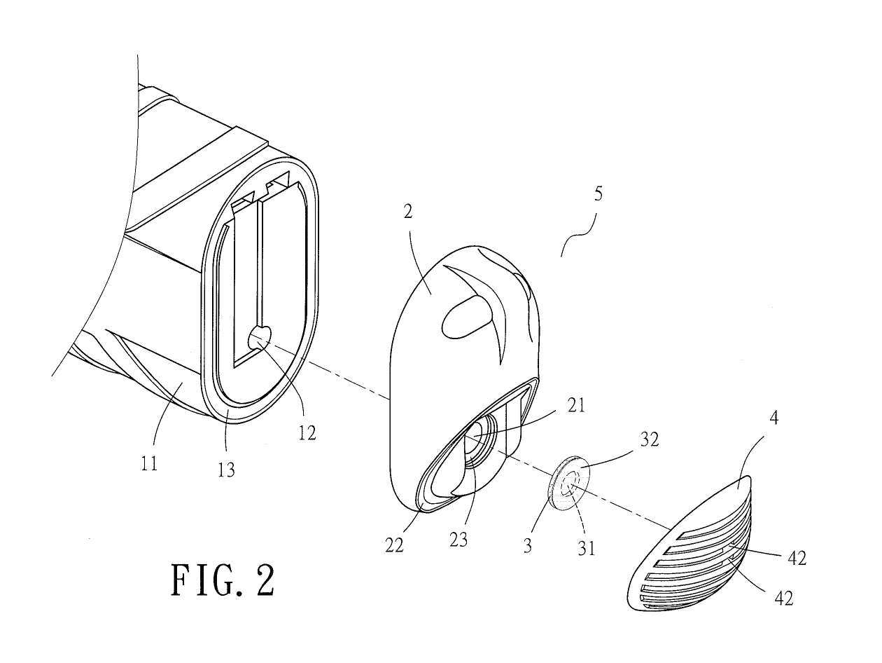

A flashlight ventilation structure proposed by the present invention, as shown in FIG. 1 and FIG. 2, comprises a flashlight body (1) and a ventilation lid (5) composed of a rear cap (2), a barrier (3) and a ventilation mask (4).

The flashlight body (1) is terminally formed with a vent (12) at a handle portion (11) thereof, and has a peripheral groove (13) formed along a periphery of the handle portion (11) circling the vent (12).

The rear cap (2) is a component configured to fit the periphery of the handle portion (11). The rear cap (2) has a vent (21) facing the vent (12) of the handle portion (11), a backside opposite to the handle portion (11) formed with a depressed combining region (22) (as shown in FIG. 2), a cavity (23) circling the vent (21), and a peripheral projection (24) formed along a periphery of the rear cap (2) at a side facing the handle portion (11) to correspond to the peripheral groove (13), as shown in FIG. 1.

The barrier (3) is a water-proof and air-permeable component shaped to fit the cavity (23) at the backside of the rear cap (2) in depth and diameter. The barrier (3) is formed with a through hole (31) and has a breathable fabric (32) affixed to a backside thereof.

The ventilation mask (4) is a cover shaped to fit the combining region (22) at the backside of the rear cap (2). The ventilation mask (4) has an inner side provided with an abutting section (41) penetrated by a through hole (42) (as shown in FIG. 1). The through hole (42) extends to an outer end of the ventilation mask (4) (as shown in FIG. 2).

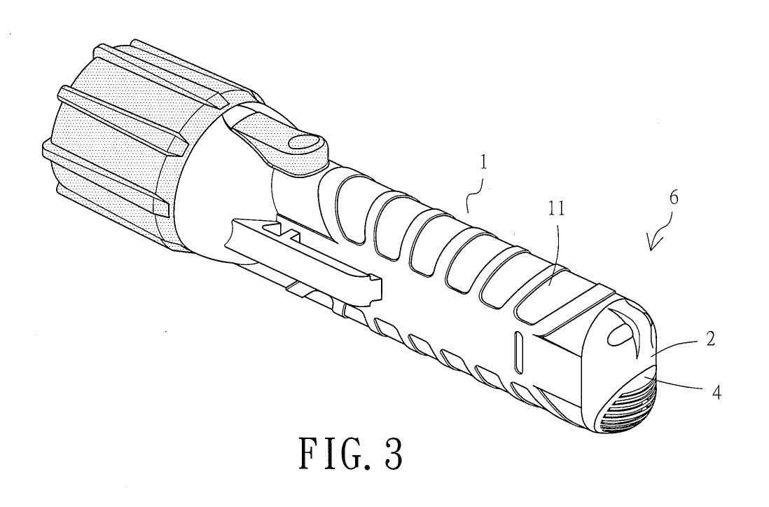

To assemble the flashlight body (1), the rear cap (2), the barrier (3) and the ventilation mask (4), as shown in FIG. 1 and FIG. 2, the barrier (3) is set in the cavity (23) at the backside of the rear cap (2). Then the ventilation mask (4) is used to cover the combining region (22) at the backside of the rear cap (2), so that the abutting section (41) extending inward from the ventilation mask (4) pressingly abuts against the corresponding barrier (3). Afterward, a high-frequency means is used to combine the ventilation mask (4) with the rear cap (2) at peripheries thereof. The rear cap (2) combined with the ventilation mask (4) is assembled to the terminal of the handle portion (11) of the flashlight, so that the peripheral projection (24) at the inner side of the rear cap (2) is fittingly received in the peripheral groove (13) of the handle portion (11). At last, a high-frequency means is used to combine the rear cap (2) with the handle portion (11) at peripheries thereof (as shown in FIG. 3), thereby finalizing the flashlight (6) whose handle portion (11) is attached with the ventilation lid (5).

The ventilation lid (5) affixed to the handle portion (11) of the flashlight (6) allows heat generated by batteries inside the flashlight (6) for lighting a bulb to be dissipated through the vent (12) of the handle portion (11), the through hole (31) of the barrier (3) corresponding to the rear cap (2), the breathable fabric (32), and the through hole (42) of the abutting section (41) of the ventilation mask (4). Thereby, the batteries inside the flashlight (6) can have the heat they generate properly dissipated, while the breathable fabric (32) at affixed to the barrier (3) provided in the in rear cap (2) prevents external liquid from permeating into the flashlight, thereby ensuring explosion-proof security when the flashlight is used in special workplaces.

What is claimed is:

1. A flashlight ventilation structure, comprising a ventilation lid screwed at a terminal of a handle portion of a flashlight;
the flashlight ventilation structure being characterized in: the flashlight having the handle portion formed with a vent so that a rear cap formed with a vent facing the vent is allowed to fittingly cover the terminal of the handle portion, the rear cap having a backside formed with a depressed combining region and a cavity circling the vent of the rear cap, so that a barrier whose backside is combined with a breathable fabric is allowed to be set in the cavity, the barrier being formed with a through hole so as to allow gas to be dissipated outward through the breathable fabric, the combining region at the backside of the rear cap being fitting covered by a ventilation mask, and the ventilation mask having a side opposite to the backside provided with an abutting section that is penetrated by a through hole, wherein the pressingly abutting section serves to abut the barrier set in the cavity of the rear cap;
whereby the ventilation lid attached to the handle portion of the flashlight allows heat generated by batteries inside the flashlight for lighting a bulb of the flashlight to be dissipated outward through the ventilation lid, while the breathable fabric in the ventilation lid prevents external liquid from permeating into the flashlight, thereby ensuring explosion-proof security when the flashlight is used in special workplaces.

2. The flashlight ventilation structure of claim 1, wherein a high-frequency means is used to combine the handle portion of the flashlight with the rear cap at peripheries thereof and to combine the ear cap with the ventilation mask at peripheries thereof.

3. The flashlight ventilation structure of claim 1, wherein the flashlight has a peripheral groove formed along a periphery of the handle portion circling the vent, while the rear cap has an inner side formed with a peripheral projection corresponding to the peripheral groove, so that when the rear cap is assembled to the handle portion, the peripheral groove is fittingly received in the peripheral groove, thereby ensuring reliable combination between the rear cap and the handle portion.
